(19) United States
(12) Patent Application Publication
(10) Pub. No.: US 2008/0231464 A1
(43) Pub. Date: Sep. 25, 2008

(54) Targeted switching of electrical appliances and method

(76) Inventors: Mark E. Lewis, Houston, TX (US); Jose Luiz Yamada, Houston, TX (US)

Correspondence Address: Mark R. Wisner;Wisner & Associates, Suite 400, 1177 West Loop South, Houston, TX, 77027-9012, US

(21) Appl. No.: 12/002,089

(22) Filed: Dec. 14, 2007

Related U.S. Application Data
(60) Provisional application No. 60/920,032, filed on Mar. 24, 2007.

(51) Int. Cl. H04Q 1/00

(52) U.S. Cl. 340/825

(57) ABSTRACT

A system and method for targeted, remote switching of electrical appliances. The system includes a transmitter for selectively producing a directional output signal and a receiver for detecting the directional output signal from the transmitter. The receiver produces an output signal when the directional output signal from the transmitter is detected that is received by a microcontroller that is incorporated into a switch controller. The microcontroller produces an output that switches the electrical appliance to which the switch controller is connected on and/or off. Although not limited to this use, the system and method of the present invention are particularly adapted for controlling individual light fixtures, even though several fixtures are wired into a single circuit, allowing the individual fixtures to be switched on and/or off as needed and, in the case of light fixtures with multiple bulbs, the dimming of the fixture by switching individual bulbs in the fixture off.

### CROSS REFERENCE TO RELATED APPLICATION

This application claims the benefit of U.S. Provisional Application No. 60/920,032, filed Mar. 24, 2007, which related patent application is hereby incorporated in its entirety by this specific reference thereto.

### BACKGROUND OF THE INVENTION

The present invention relates to a method and system for switching electrical appliances such as light fixtures, and/or individual light bulbs or groups of bulbs, in a light fixture, on and/or off. In more detail, the present invention relates to a method and system that enables the user to switch an individual electrical appliance on and/or off from a remote location using a wireless directional transmitter. Although not limited to this use, the targeted on/off switching system and method of the present invention are particularly useful for switching and/or dimming individual light fixtures, particularly high bay lighting fixtures in commercial applications, that are wired into the same circuit with other like fixtures by turning one or more of the bulbs in an individual fixture on and/or off as needed for safe and energy efficient lighting of building interiors even in installations in which the on/off switch for the fixture is not located at the entrance to a building, room, or other location that needs to be lighted, and without the need to re-wire the fixture or the circuit in which the fixture is wired and without the need to string communication/control cables from a control panel or computer to the light fixtures.

A substantial portion of electrical consumption is utilized for lighting. In the face of increasing energy costs, it is therefore important for retail, institutional, industrial, and warehousing operators, and the operators of other commercial and public installations, to minimize the use of electricity for lighting. This need has been partially addressed with techniques such as daylight harvesting and more efficient lighting systems, for instance, by replacing metal halide lights with fluorescents and by the relatively recent introduction of so-called electronic “instant on” and “programmed start” ballasts for fluorescent fixtures and dimmable ballasts for fluorescent and metal halide fixtures. By using instant on and programmed start ballasts for fluorescent fixtures and wiring fixtures into groups that are switched independently of other groups of fixtures as needed for operations in the commercial or public installation, substantial reductions in energy consumption have been achieved. Even so, there is room for improvement in energy cost savings, and there are many installations still using metal halide lights and in which the cost of replacing the lights with fluorescent lighting and/or re-wiring is substantial enough that the operators have not retrofit the installation for this purpose. Further, electric rates for some commercial installations are calculated on the basis of peak power load, so there is a need to reduce the component of electrical power cost that is based on peak power consumption. This latter need has, so far as is known, not been addressed effectively by so-called point of use strategies for decreasing lighting power consumption and/or peak power consumption.

Remote on/off switching systems are available for switching a ceiling fan and/or light on or off in a room or building. So far as is known, however, the only such systems capable of distinguishing between multiple electrical appliances in a room or building are characterized by their operational limitations, complication, and/or their installation cost. Such systems are available from, for instance, Sensor Switch, Inc. (Wallingford, Conn. and Port Perry, Ontario, www.sensorswitch.com), which markets a so-called “Hospital Bed Light Controller” that is retrofit to existing “pull chain” controlled hospital bed wall lights and operated by an infrared (IR) receiver/controller and an IR transmitter with a range of 8-10 feet. The advertising for the Hospital Bed Light Controller claims that a nurse with one remote can control all the wall lights on the ward or floor of the hospital. Though useful for use in a small room, the range limitations of this system do not allow for effective use unless the operator is close to the wall lights.

U.S. patent Publication No. US2005/0025480 describes a laser-activated photoresistor for on/off switching, but a photoresistor is too slow acting for many applications and merely switches on/off with no operating flexibility. Further, the laser-activated photoresistor is susceptible to ambient light such that switching can occur as a result of, for instance, a flashing light or even incident sunlight. The slow response of the photoresistor severely limits the useful range of the remote for this system due to incremental laser movements resulting from shaking or natural movements in hand held operations. U.S. Pat. No. 6,252,358 (and many other systems) use radio frequency (RF) control to switch fixtures, but such systems are complicated and therefore not well suited for use in commercial installations in which many fixtures must be controlled. Further, RF systems are not targeted to specific fixtures and/or individual bulbs or groups of bulbs such that in the absence of encoding of the RF signal (and the resulting complexity of operation), fixtures are switched that are not intended to be switched.

U.S. Pat. Nos. 4,897,883 and 6,828,733 disclose handheld IR transmitters said to be capable of switching individual fixtures. However, the systems described in those patents utilize encoded IR signals and pre-programmed, separately addressable IR receivers mounted to the fixtures controlled from the handheld transmitter to switch individual fixtures, requiring increased operational complexity and cost of installation, especially in installations with many fixtures.

So-called DALI (digital addressable lighting interface) systems are available (from, for instance, Specialized Lighting Solutions, Beaverton, Oreg., and Complete Technology Integrations Pty Ltd, North Ryde, NSW (and other cities in Australia)). Although impressive in their capabilities and operational flexibility, such systems are expensive to purchase and install, may require specialized programming or re-programming when changes are needed in a particular installation, and are operationally complex.

It is, therefore, an object of the present invention to provide an on/off switching and/or dimming system for the lights in a commercial installation that enables individual light fixtures, and/or the bulbs or groups of bulbs in an individual light fixture, to be turned on and/or off as needed even when several such fixtures are wired into the same circuit. Although not limited to this application, the on/off switching system of the present invention is particularly useful for switching so-called high bay lighting in industrial buildings. Those skilled in the art who have the benefit of this disclosure will recognize that such lighting is also utilized in retail buildings and in warehouses, and that the present invention may also be used for switching light fixtures in buildings such as theaters, auditoriums, schools, gymnasiums, and any building in which the cost of energy for lighting is high enough that cost savings are desirable. The on/off switching system of the present invention is also utilized for switching and/or dimming outdoor canopy lights and other outdoor lighting fixtures in, for instance, athletic fields, vehicle parking lots and parking garages, vehicle storage lots, docks, freight terminals, railroad switching yards, construction sites, and anywhere else where lights are needed for outdoor operations.

Another object of the present invention is to provide a switching system and/or dimming system for the lights in a commercial building or other indoor or outdoor installation that utilizes existing wiring and light fixtures in the installation so as to avoid the cost of re-wiring and/or replacing the light fixtures while still enabling individual fixtures, or individual bulbs in fixtures having multiple bulbs, to be turned on and/or off as needed to provide the light necessary for the safety and security of operations in the space illuminated by individual fixture(s). Depending upon the cost of the electricity, the amount of light needed, and the level of control desired, installation of the switching system of the present invention can achieve such energy savings that the savings could pay for the cost of installing the switching system of the present invention in as little as a year.

Another object of the present invention is to provide a method of switching individual light fixtures, and/or the bulbs or groups of bulbs in a fixture with multiple bulbs, on and/or off without switching other light fixtures that are wired into the same circuit using a narrow, focused output signal from a transmitter that is aimed at a sensor located on the specific light fixture to be switched on and/or off.

Another object of the present invention is to provide a system and method that allows lights or other electrical appliances to be switched on in sequence, or one light fixture or appliance at a time, even when the lights or appliances are all wired into a single circuit, for the purpose of reducing the peak power that would otherwise be required to turn on all the lights or appliances wired into that circuit.

Another object of the present invention is to provide on/off switching and/or dimming for the light fixtures in a commercial installation that is adaptable for different levels of control of the lights, for instance, at one level by employees or other personnel at the installation for use during shift operations and at a second level by supervisory or on-premises security personnel for instance, after employee shift operations have ended.

Yet another object of the present invention is to provide an on/off switching and/or dimming system that can operate across open spaces where it is not practical, and sometimes where it is not even possible, to install wiring for connecting an electrical appliance to a control system of the types that are presently available.

Another object of the present invention is to provide on/off switching and/or dimming system for lights where the lights can be controlled from various and distant locations where it is advantageous for operator not to reveal his/her position such as in a hostile environment and/or in military, security, or surveillance operations.

Another object of the present invention is to provide a switching system including a remote transmitter that produces a low divergence beam, enabling a specific appliance to be switched without switching other appliance(s) even when closely spaced.

Similarly, it is an object of the present invention to provide an on/off switching and/or dimming system that enables the control of appliances even through walls, around corners, and around natural or man-made barriers.

Another object of the present invention is to provide a switching system for the lights in a commercial installation that works well and provides operational flexibility with programmable lighting systems of the type used, for instance, for daylight harvesting, with timers, and with photo-sensing and motion-sensing fixtures, while still enabling operation by untrained personnel who can control the fixtures, or the individual bulbs of a fixture with multiple bulbs, without operating a central control console, switch pad, or computer.

Although described herein as being useful for controlling light fixtures, those skilled in the art will recognize from this disclosure that the targeted switching system and method of the present invention is also intended for switching other types of electrically-activated devices, for instance, electrical motors, sensors, and components of security systems. For that reason, the term “electrical appliance” is used herein for the purpose of describing other devices that can be switched on and/or off with the system and method of the present invention and all references to lights and light fixtures herein should be construed as references to electrical appliances. Consequently, in a broader sense, it is an object of the present invention to provide a switching system and method for switching any electrically-activated device as needed for energy cost savings and other purposes.

This listing of several of the objects of the present invention is intended to be illustrative, and is not intended to be a complete listing of all of the objects of the invention. Other objects, and many advantages of the present invention, will be made clear to those skilled in the art in the detailed description of the preferred embodiment(s) of the invention and the drawings appended hereto. Those skilled in the art will recognize, however, that the embodiment(s) of the present invention described herein are only examples of specific embodiment(s), set out for the purpose of describing the making and using of the present invention, and that the embodiment(s) shown and/or described herein are not the only embodiment(s) of a targeted on/off switching system and method constructed and/or performed in accordance with the teachings of the present invention.

### SUMMARY OF THE INVENTION

The present invention addresses the above-described needs by providing a system for switching an electrical appliance comprising a portable transmitter for selectively producing a directional output signal and a receiver having a sensor for producing an output when the directional output signal from the transmitter is detected by the sensor. A switch controller comprising a microcontroller and a connector adapted for connecting to an electrical appliance receives the output from the receiver and outputs a signal to the electrical appliance through the connector for switching the electrical appliance.

Also provided is a system for dimming a light fixture having multiple bulbs by switching one or more of the bulbs in the fixture on and/or off comprising a portable transmitter for producing a directional output signal and a receiver having a sensor for producing an output when the signal from the transmitter is detected by the sensor. A switch controller comprising a microcontroller and a connector adapted for connecting to individual bulbs in a light fixture receives the output from the receiver and outputs a signal to selected bulbs in the fixture through the connector for switching the bulbs.

In another aspect, the present invention provides a method of switching an electrical appliance comprising the steps of activating a transmitter to produce a directional output signal and aiming the transmitter at a sensor located on an electrical appliance. A signal is output from the sensor when the sensor detects the output signal from the transmitter and a signal is output from a microcontroller upon receipt of the output signal from the sensor by the microcontroller. Upon receipt of the output signal from the microcontroller, the electrical appliance is switched.

### BRIEF DESCRIPTION OF THE DRAWINGS

Referring now to the figures, FIG. 1 is a diagrammatic view of an open-frame building with high bay lights installed and wired in a manner commonly utilized in which the targeted switching system of the present invention is advantageously installed.

FIG. 2 is a schematic diagram of a preferred embodiment of a switching system in accordance with the present invention for use in a building as shown in FIG. 1.

FIG. 3 is a schematic diagram of the circuitry comprising a presently preferred embodiment of the remote transmitter of the targeted switching system of FIG. 2.

FIG. 4 is a diagrammatic view of a second embodiment of the receiver of the switching system of FIG. 2.

FIG. 5 is a diagrammatic view of the low divergence output signal of the remote transmitter of the targeted switching system of FIG. 2.

FIG. 6 is a logic diagram showing a presently preferred embodiment of the control software for implementing the method of the present invention.

FIG. 7 is a logic diagram of a preferred embodiment of a program for controlling the targeted switching system of FIG. 2 that includes the capability of switching individual bulbs in a fixture including multiple bulbs for the purpose of dimming the light produced by the fixture.

FIG. 8 is a logic diagram of a preferred embodiment of a program for controlling the targeted switching system of FIG. 2 including an ambient light sensor as shown in FIG. 4.

FIG. 9 is a top plan view of a second embodiment of a remote transmitter for use with the targeted switching system of FIG. 2 that is adapted for dimming a fixture by switching individual lights in a fixture including multiple bulbs on and/or off.

### DETAILED DESCRIPTION OF THE PREFERRED EMBODIMENT(S)

In more detail, a common type of commercial building is the open-frame building 10 shown in diagrammatic sectional view in FIG. 1. Such buildings are built on a concrete slab or pad 12 with metal walls 14 and a roof 16 supported by beams or girders (shown as part of the roof in FIG. 1 for purposes of convenience). In a typical open frame building, two, four, six, or more bulb fluorescent light fixtures 18 are suspended from the beams or girders supporting roof 16 at spaced intervals and two, four, six, eight, or more such fixtures 18 (two such fixtures 18 being visible in the sectional view shown in FIG. 1) are wired into a circuit 20 that is switched from a wall-mounted on/off switch 22 located near a door or entrance 24 into the room or building. Although the construction and high bay lighting shown in FIG. 1 is widely utilized because of its reliability, flexibility, and utility, problems arise when, for instance, one enters a dark building from the door or entrance 26 on the wall opposite the door/entrance 24 where the wall-mounted switch 22 is located. Of course the circuit 20 can be wired with multiple switches to solve the problem of lack of light when entering through door 26, but additional switches increase installation costs.

Another problem arises when operations are conducted under only one or two of the several light fixtures 18 controlled from a single switch 22. Although the light from other fixtures in circuit 20 is not needed for operations under specific fixtures 18, all the fixtures are powered on because they are all wired into circuit 20. Another problem arises when operations requiring less light than the light output by all the bulbs in a fixture 18 are conducted under light fixtures 18 controlled from the same switch 22. Although the light from the other fixtures in circuit 20 may not be needed for operations under specific fixtures, or less light may be needed than the light produced by the bulbs in the fixture under which operations are conducted, all the bulbs in all the fixtures 18 are powered on because all the fixtures 18 are wired into circuit 20. As a result, energy consumption and peak load are increased as compared to operating just one or two specific fixtures 18A and 18B in circuit 20 or fewer than all the bulbs mounted in fixtures 18A and 18B.

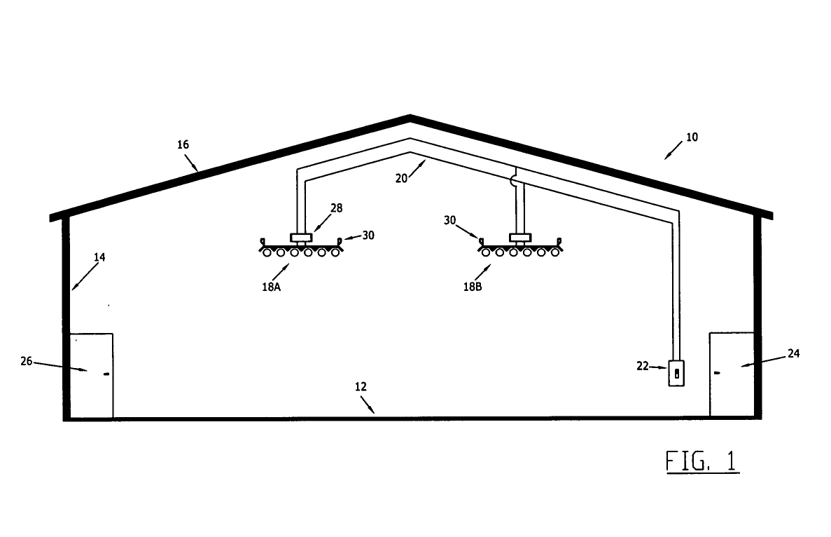

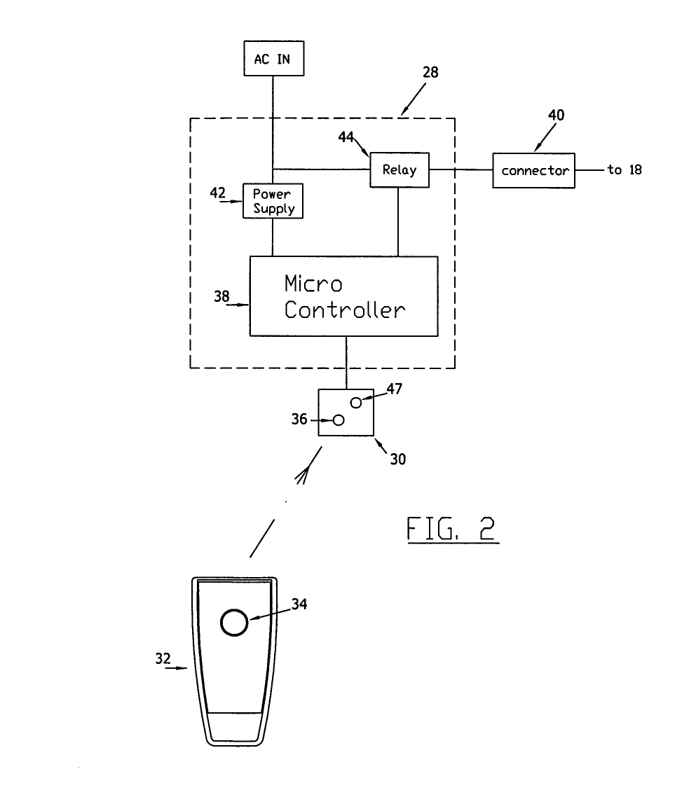

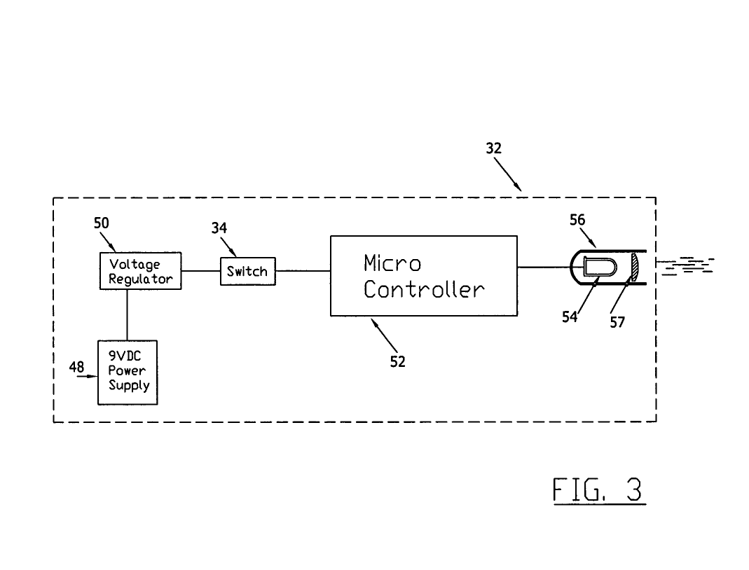

To address these (and other) problems, the circuit 20 is provided with the components (shown out of scale for purposes of illustration) of a targeted switching system constructed in accordance with the present invention. Specifically, each of light fixtures 18 is provided with a switch controller 28 having one or more receivers 30 operably connected thereto. In the embodiment shown in FIG. 1, receivers 30 are mounted to opposite sides of light fixtures 18 to receive a signal from a portable remote transmitter 32 (not shown in FIG. 1; see FIGS. 2 and 3) that is, for instance, carried by a person to turn an individual fixture 18A or 18B on or off from either of doors 24 or 26. As can be seen in FIG. 1, and as set forth below, switch controllers 28 function to turn individual fixtures 18 on or off even when multiple fixtures are wired into the same circuit 20.

A first embodiment of the switching system of the present invention is shown in FIG. 2. The system is comprised of switch controller 28, one or more receivers 30 operably connected to switch controller 28, and portable transmitter 32. Transmitter 32 includes an infrared (IR), laser, or other light-emitting source that is selectively activated by pushing on/off button 34. The particular transmitter 32 shown in FIG. 2 utilizes IR output signals and the resulting beam is focused (as described below) to a low divergence beam, achieving a directionality that enables transmitter 32 to be aimed at the receiver 30 on an individual light fixture 18 to be switched when button 34 is pushed. By aiming the transmitter 32 at an individual fight fixture 18, the directional output signal produced by transmitter 32 is detected only by the sensor 36 of controller 28 mounted to the targeted fixture 18. The sensor 36 of receiver 30 mounted to the targeted light fixture 18 produces an output to the microcontroller 38 of switch controller 28. Microcontroller 38 is configured so that when an output is detected from sensor 36 of receiver 30, a signal is output to light fixture 18 through a connector 40 and mechanical or solid state relay, or other appropriate switching device, 44 to switch the light fixture. Switch controller 28 additionally comprises a power supply 42 as known to those skilled in the art.

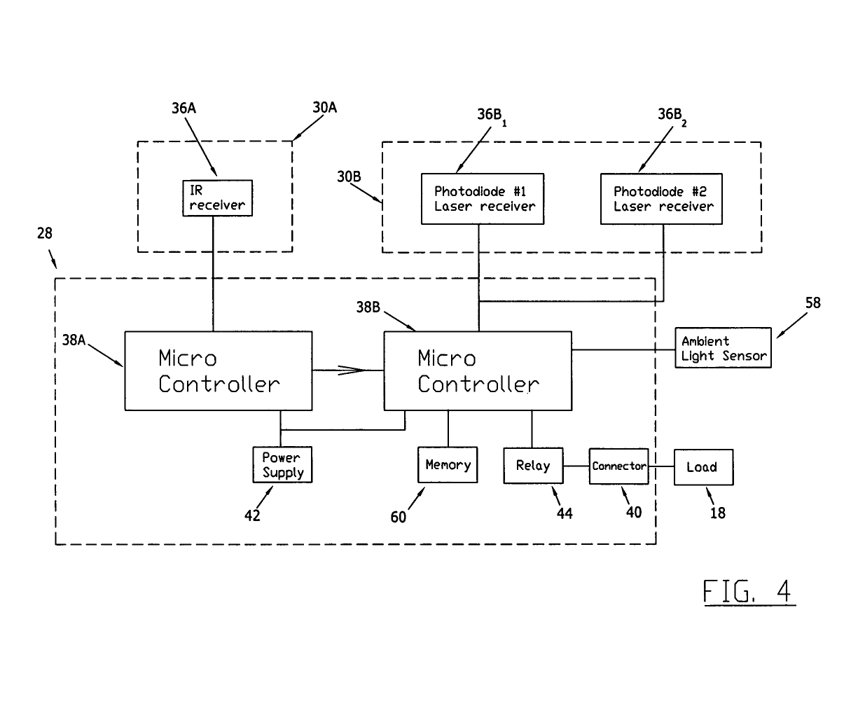

The sensor 36 of receiver 30 is preferably comprised of a photodiode, or even more preferably an array of photodiodes, because of their quick response. Because the receiver is mounted to a light fixture 18 that must be switched on to provide light as desired, the light fixture may be located in partial, or even total, darkness such that it may be difficult to see a specific fixture to be turned on with portable transmitter 32. Consequently, receiver 30 may also be provided with an LED target 47 located in close proximity to the sensor 36 so that a directional signal output from transmitter 32 that is aimed at the target 47 is detected by sensor 36. Of course those familiar with lighting design will recognize that a sensor that detects an incident laser beam may produce an output signal when light is detected from the lighting fixture to which it is mounted, visible light from a passing vehicle or other source (such as the strobe light or headlights of a passing forklift truck), or natural light (none of which are concerns for IR sensors). Consequently, if sensor 36 detects a laser beam, receiver 30 is either mounted above the light fixture (see FIG. 1) or, if receiver 30 is mounted in or under fixture 18, shielded from the light produced by fixture 18 (or other light sources) so that the sensor 36 does not produce an output signal when the light fixture itself is switched on. Alternatively, the microcontroller 38 is provided with a sensor and programming for adjusting sensitivity (see FIG. 4). Of course it will be recognized by those skilled in the art who have the benefit of this disclosure that if the sensor 36 is a detector for incident laser beams, and if the switch controller 28 is mounted to an electrical appliance that is located outdoors, providing microcontroller 38 with a sensor and programming for adjusting sensitivity provides a way to avoid switching the electrical appliance on/off in response to changes in ambient lighting, and coincidentally, provides a system that is extremely sensitive to an incident laser beam in low ambient light conditions. Operation of the embodiment shown in FIG. 4, which includes an ambient light sensor 58, is described below. Of course if the receiver 30 including sensor 36 is mounted above a directional light fixture, the receiver 30 is located in at least partial darkness even when the bulb(s) in the fixture is/are switched on so that the target 47 may be an important component for operation and use of the system and method of the present invention even when the bulb(s) is/are switched on.

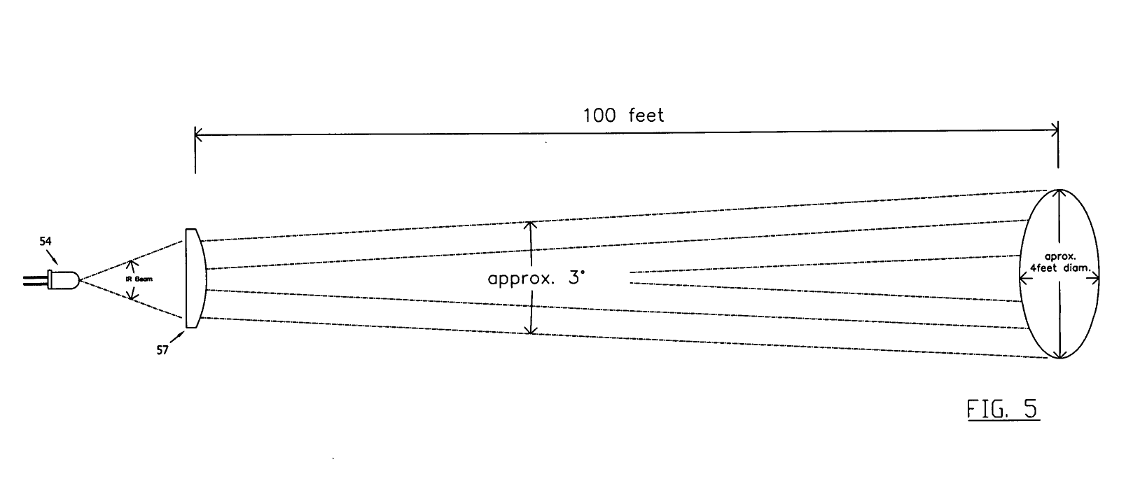

Referring again to FIG. 3, in one embodiment, transmitter 32 is comprised of a power supply in the form of battery 48 and voltage regulator 50 for powering a microcontroller 52 when switch 34 is closed at the voltage requirements for the particular microcontroller 52. The output from microcontroller to LED 54 is utilized to pulse LED 54 on and off so as to encode the IR output from LED 54. In the preferred embodiment, the IR beam produced by LED 54 is a low divergence beam produced by narrowing the beam with an optical or mechanical focus. Of course the spread of the IR beam is a function of the distance between LED 54 and the target 47 of a particular fixture 18, and so the degree of divergence of the IR beam for optimal control of individual fixtures is likewise a function of distance. In one embodiment, for instance, the LED 54 in transmitter 32 produces an IR beam with sufficient intensity that it has a useful range of about 100 feet. It has been found that, for such a transmitter, it is useful to restrict, or narrow, the IR beam produced by LED 54 so that the size of the beam is approximately 3-5 feet at a distance of 100 feet as shown schematically in FIG. 5. To obtain a beam of that size at that range, it has been found that limiting the divergence of the IR beam to an angle of approximately 3° (or approximately 1.5° from the central axis of the beam) facilitates the targeting of specific receivers 30 mounted to specific electrical appliances, but the present invention is not considered to be restricted to an IR output signal of that angle.

In one embodiment as shown in FIG. 3, the narrowing, or restricting, of the IR output beam is accomplished by mounting LED 54 in a recess 56 with a relatively narrow opening to decrease the divergence of the output signal from transmitter 32. Those skilled in the art who have the benefit of this disclosure will recognize that limiting the divergence of the directional output signal from transmitter 32 can be accomplished in other ways such as by use of a lens, lens set, mirror, mirror and lens, coated mirror, lens, or lens set, or a mechanical restrictor so long as divergence of the output signal is limited to the point that it can be targeted to a specific receiver 30 on a light fixture 18 that is intended to be switched without switching an adjacent light fixture. One way to focus the beam produced by LED 54 so that divergence of the IR beam is limited in accordance with the present invention, that has the benefit of increasing the operational range of the IR beam, is shown schematically in FIG. 5, showing a piano convex lens 57 that changes the IR beam produced by LED 54 from a cone-shaped beam to a substantially parallel beam. Although shown schematically in FIG. 5, those skilled in the art will recognize from this disclosure that lens 57 is spaced a fixed distance from LED 54 and fixed in place in a hood or other frame that surrounds LED 54 in transmitter 32 in a manner known in the art. Experimentation indicates that a transmitter 32 that limits divergence of the output signal with the structure shown in FIG. 5 is capable of switching individual fixtures at distances of over 300 feet, however, some of the ability of the present invention to target individual fixtures may be lost at such distances because of the divergence of the beam. Although the invention is not restricted to a beam diameter of approximately 3-5 feet, that beam diameter has been found optimal for targeting individual fixtures such that, if operating ranges of 300 feet or greater are contemplated in a particular installation, transmitter 32 is provided with a lens or lens set that limits divergence of the IR beam so that the diameter of the beam is approximately 3-5 feet at that particular operational distance.

In an alternative embodiment (not shown), the IR beam is restricted by sliding LED 54 in and out of a tubular restrictor in which LED 54 is set (or by sliding the tube in and/or out relative to LED 54), narrowing the beam for targeting a specific fixture to be switched or spreading the beam for switching multiple or widely-spaced fixtures. In another alternative embodiment, the shape of the IR beam is changed by sliding a lens or shaped restrictor (not shown) over the LED 54 to spread the beam so that, instead of a cone-shaped beam with a cross-sectional shape that approximates a circle, the cross-sectional shape of the beam is elliptical. By restricting the beam in this manner, the directional transmitter 32 can be used to quickly switch an appliance on (or off) by “swiping” the beam across the fixture so that the IR beam falls upon the target sensor 36. Because the structure described herein functions in similar fashion to produce similar results, all such structure is referred to herein as “means for limiting the divergence of the output signal” of transmitter 32. Of course if transmitter 32 outputs a laser beam, the beam generally need not be restricted or narrowed at all.

Referring now to FIG. 4, a second embodiment of a switch controller for use in connection with the targeted switching system of the present invention is shown in schematic form. In this second embodiment, the system comprises detectors 36A and 36B that produce an output signal upon detection of either or both of an infrared or laser beam produced by a transmitter (not shown in FIG. 4) such as the transmitter 32 shown in FIG. 2. Detector 36A produces an output signal to a first microcontroller 38A upon detection of an encoded incident infrared beam and the output signal from detector 36B to second microcontroller 38B results from detection of an incident laser beam. Because a laser beam is so focused, the detector 36B is preferably comprised of an array of sensors 36B₁, 36B₂, and so on, each sensor 36B₁, 36B₂ producing an output to microcontroller 38B, for ease of detection of an incident laser beam, especially when a transmitter such as transmitter 32 is aimed at detector 36B from a long distance away. Microcontrollers 38A and 38B are connected to each other, with microcontroller 38B receiving an output from microcontroller 38A depending upon whether an infrared beam has been detected by detector 36A, microcontroller 38B functioning to switch an electrical appliance in the same manner as described above in connection with FIG. 2. In the embodiment shown in FIG. 4, the system also includes the ambient light sensor 58 described above for producing an output to microcontroller 38B for adjusting the sensitivity of the detectors 36B and is provided with EEPROM or other non-volatile memory 60 to which microcontroller 38B writes whenever a change in operating state occurs in the event of a loss of power, microcontroller 38B being programmed to check the non-volatile memory when it is powered up so as to return to the last operating state upon restoration of electrical power. If microcontroller 38B is programmed to return to the last operating state when power is restored, it may also be useful to delay the switching of the electrical appliance connected to relay 42 for the purpose of reducing peak power demand as described above. Those skilled in the art will recognize that a back-up battery can be provided for maintaining current operating state in the event of a loss of power rather than non-volatile memory.

The method and system of the present invention also contemplate the use of a remote transmitter that produces encoded output signals that is provided with a switch for selectively encoding the directional signal output by the transmitter for changing operating functions of switch controller 28. In this embodiment, the switch is provided with settings for producing multiple encoded directional outputs, for instance, a main on/off signal, an over-ride signal as described below, a signal that changes the filtering parameters of switch controller 28 as described below, a signal for changing the sensitivity of switch controller 28 as described above in connection with ambient light sensor 58, and a setting for a signal that activates a diagnostics and/or re-set routine programmed into microcontroller 38. The signal for selecting the filtering parameters of switch controller 28 from two or more sets of filters programmed into microcontroller 38 is used to filter out spurious signals such as might be produced by safety strobe lights. The “over-ride” signal is utilized to set microcontroller 38 in a mode in which on/off signals output from the remote are ignored either for a selected period of time or until a second over-ride signal is received. This over-ride signal is useful in installations in which, for instance, security and/or safety standards require selected light fixtures to remain switched on at all times, and prevents those selected fixtures from being switched off by the main on/off encoded signal output by the remote transmitter. The ability to re-program the switch controller with the remote provides a safety advantage because the fixture is often positioned high above the floor and is connected in a circuit that may be operating at 480 volts.

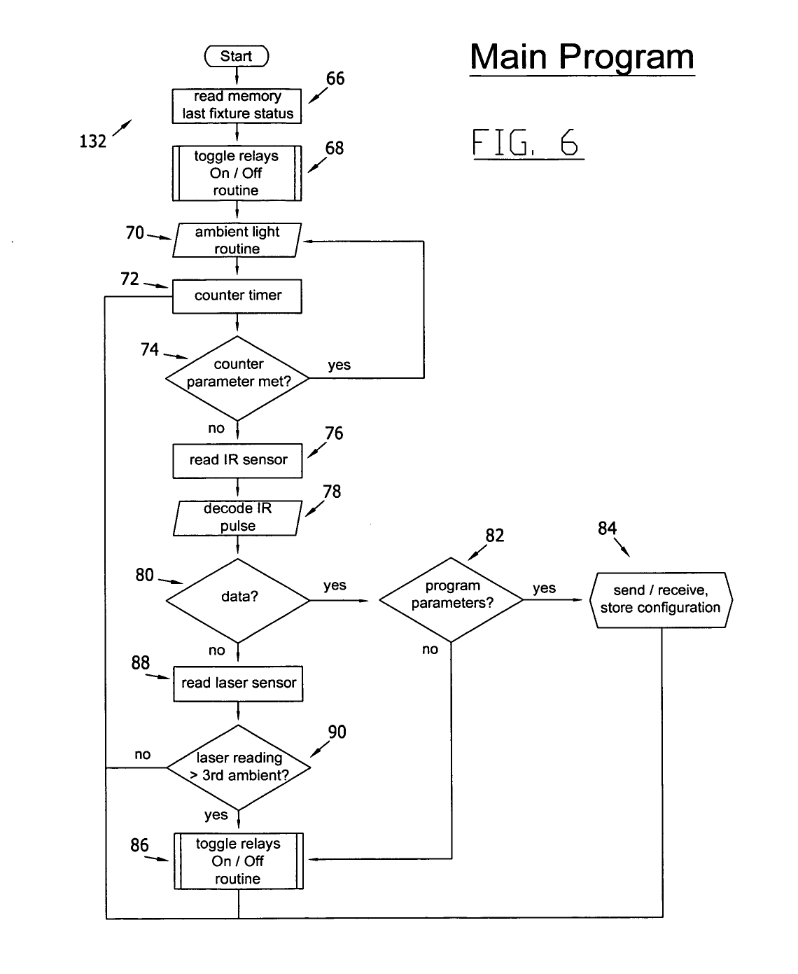

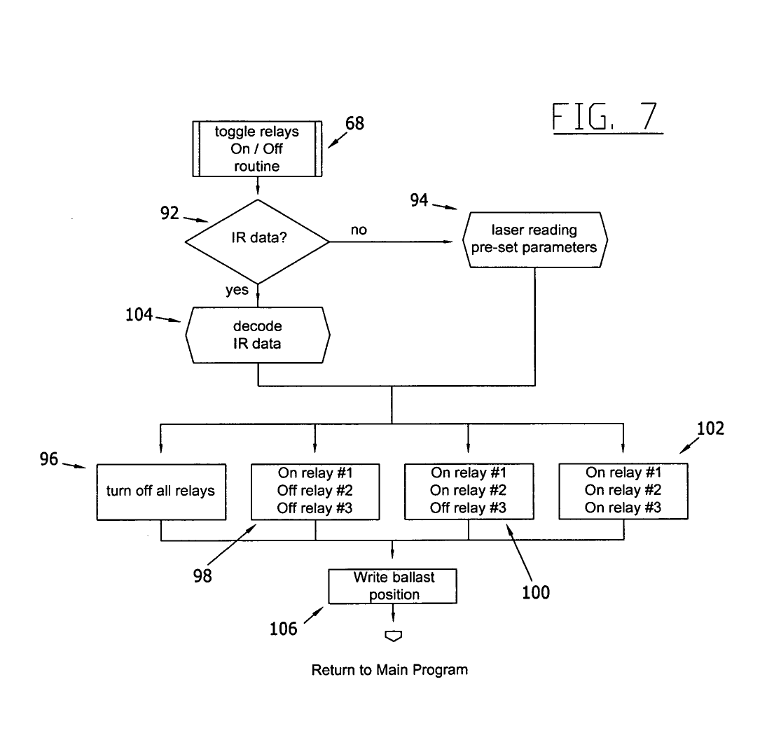

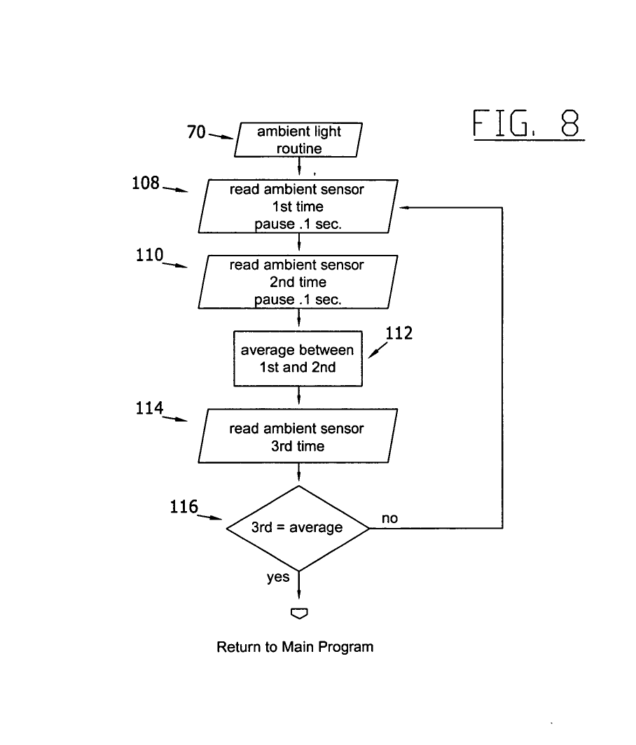

Referring now to FIG. 6, there is shown a flow chart of a presently preferred embodiment of a program that may be stored in the memory of the microcontroller 38 for implementing a method utilizing the targeted on/off switching system of the present invention. In the particular embodiment shown, the program commences with the step 66 of reading the last operating status of a fixture or appliance (such as the fixture 18 shown in FIG. 1). In the particular embodiment contemplated in FIG. 6, the control software includes software for dimming a light fixture in which multiple bulbs are mounted as implemented by the toggle relays on/off routine 68 shown in more detail in FIG. 7 and described below. In the next step, the output from the ambient light subroutine 70, shown in detail in FIG. 8 and described below, is read and counter/timer 72 is checked. If the counter parameter is met as at step 74, the ambient light routine is sampled again and the method cycles through counter/timer 72 until the counter parameter is not met, after which the output from sensor 36 is read at step 76.

If the data read by IR sensor 36A (see FIG. 4) is an IR pulse that can be decoded as at step 78 such that data is present at step 80, a check to see if the data meets the program parameters is made at step 82. If program parameters are met and as shown at step 84, microcontroller 38 sends and/or receives and stores to memory in accordance with the program stored in the memory of the microcontroller 38, the method cycles back through counter/timer 72 and repeats. If the parameters are not met, the output from toggle relays on/off routine 68 (FIG. 7) is checked again at step 86 and the method cycles back through counter/timer 72 and repeats. If data is not present at step 80, the output from laser sensor 36B (see FIG. 4) is checked at step 88 and compared at step 90 to the third ambient reading/average from ambient light subroutine 70 (see FIG. 8). If less than the third ambient reading/average from ambient light subroutine 70, the method again cycles back through counter/timer 72, but if the output from laser sensor 36B is greater than the third ambient reading/average from ambient light subroutine 70 by a pre-selected margin, the output from the above-described toggle relays on/off routine 68 shown in FIG. 7 is checked as shown at step 86 and the method then cycles back through counter/timer 72.

Referring now to FIG. 7, the toggle relays on/off routine 68 is shown in detail. This routine 68 is intended for use with multiple bulb fixtures in which each bulb, or a set of two or more bulbs, is switched independently of the other bulbs. However, those skilled in the art will recognize from this disclosure that routine 68 may also be used for switching multiple blower fans or other electrical appliances. A single light fixture may have four, six, eight, or even more light bulbs with, for instance, two ballasts (not shown) for controlling two bulbs each, two ballasts controlling two and four bulbs each, three ballasts controlling three bulbs each, three ballasts controlling two, four, and four bulbs each, and so on. Each ballast is switched by a respective relay (not shown) such that the light output from the fixture depends on the number of bulbs switched on, hence the reference herein to the use of the method and system of the present invention for dimming a light fixture. Of course those skilled in the art will recognize that the fixture need not be a fluorescent fixture and that the present invention is also useful for dimming an incandescent or metal halide light fixture with multiple bulbs. The toggle relays on/off routine 68 starts with a query 92 for the presence of IR data as would be output from the IR sensor 36A described above. If no such data is present, a check is made as at 94 for a laser reading that meets the pre-set parameters of length and time and the routine 68 then continues by either turning off all relays 96, turning one relay on and others off 98, turning two relays on and the other off 100, turning three relays on 102, and so on in accordance with the pre-set parameters. If IR data is present, the data is decoded as at step 104 and the relays are turned on and/or off as described at steps 96, 98, 100, 102. Ballast position is then written to memory 106 and output to the main program as at step 68 (FIG. 6).

In another embodiment (not shown), one of the parameters utilized to control the system of the present invention is time, microcontroller 38 being programmed so that if the expected IR data or laser data is detected at step 92, 94 within a selected time period, for instance, ten seconds, the next signal detected switches the bulbs in the fixture (or certain bulbs or groups of bulbs) off. Because the last operating state is written to memory as at step 106, when sensor 36A next detects a signal, the fixture is switched back to the last operating state, e.g., with 2, 4, 6, etc. bulbs turned on.

Referring now to FIG. 8, the ambient light subroutine 70 is shown in detail. Ambient light subroutine 70 is commenced by reading the output from ambient light sensor 58 (see FIG. 4) at step 108 and pausing for a predetermined interval (0.1 sec. in the case of the presently preferred embodiment), reading the output from ambient light sensor 58 a second time at step 110 and pausing again, and then averaging the two readings at step 112. The output from ambient light sensor 58 is then read a third time at step 114 and the third reading is compared to the average of the first two readings at step 116. If the third reading is equal to (or falls within a pre-set range relative to) the average of the first two readings, the reading is output to the main program as at step 70 (FIG. 6). If the third reading varies from the average of the first two readings, the routine 70 cycles back to step 108 on the assumption that the readings from ambient sensor 58 were caused by a flashing light or other light source that is not intended to constitute an input that changes the settings and/or operational status of microcontroller 38.

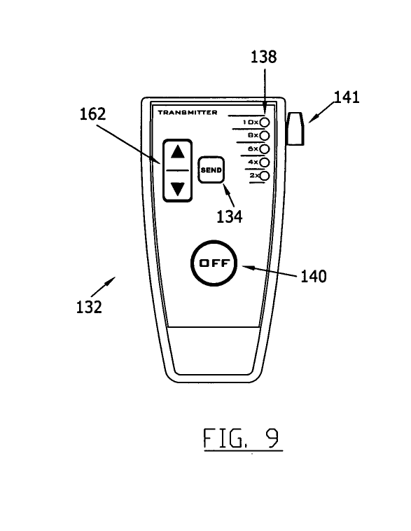

Referring now to FIG. 9, an alternative embodiment of a remote transmitter for use in connection with the present invention is indicated generally at reference numeral 132. Transmitter 132 is specifically intended for dimming functions in accordance with the method described in connection with FIG. 8. Transmitter 132 is provided with a send/on button 134 and up/down selectors 162 for controlling operation often bulbs in a fixture as described above, LED/indicator lights 138 providing visual confirmation of the operational status of the bulbs in the fixture. A master off button 140 allows all the bulbs in the fixture to be turned off with a single key stroke and, as described above, the operational status of transmitter 132 is written to memory so that when send/on button 134 is pressed again, the same number of bulbs are illuminated. As described above, limiting divergence of the beam output by transmitter 132 is an important aspect of the ability of the switching system of the present invention to target an individual light fixture 18 or other appliance and the switching system of the present invention has been shown to have operating ranges of over 300 feet. At such operating ranges, the ability of the operator of the transmitter 132 to target an individual appliance is facilitated by the use of a sight that is integral with transmitter 132, a tubular sight 141 being shown for that purpose in FIG. 9 (of course transmitter 32 shown in FIG. 2 may also be provided with a visual alignment, or sighting, aid). Those skilled in the art will recognize that other visual sighting aids may take the form of a line or groove on the outside surface of remote 132, a pop-up peep sight, spotting scope, or even a laser source that is integral with transmitter 132.

Those skilled in the art who have the benefit of this disclosure will recognize that the targeted switching system of the present invention provides opportunities for operating flexibility that, on information and belief are not available in previously known remote switching systems. For instance, with the ability to produce an encoded signal and the addition of a transmitter mounted to a light fixture to be switched with the present system, the remote transmitter can switch multiple light fixtures. For instance, the transmitter can be set to a dedicated position for producing an encoded, targeted output signal that is detected by a switch controller 28 mounted on a specific light fixture to cause that specific light fixture to switch on/off. The microcontroller 38 in the switch controller 28 of that specific light fixture may be pre-programmed to produce an output signal to a transmitter that, like switch controller 28, is mounted to that specific light fixture and that produces an output signal targeted to a second specific light fixture at some location to cause that second specific light fixture to turn on/off. Likewise, the second specific light fixture may be provided with a transmitter for producing an output signal for activating a third specific light fixture and so on, and any one or more of the fixtures in such a sequence may be provided with timer(s) for switching the fixture(s) after a pre-selected period of time. Those skilled in the art will recognize that the output from the microcontroller 38 in the switch controller 28 mounted to the first specific light fixture may be delayed so that the second specific light fixture is switched, and that the transmitter on the second may likewise be delayed so that the third specific light fixture is switched, in sequence (relative to the first and second specific light fixtures) for such purposes as security or for following the movements of personnel through a building. Of course a specific fixture may have two or more transmitters mounted to that fixture for activating more than one additional light fixture. Because the output signal from the transmitter mounted on each specific fixture is targeted to the sensor(s) on second (and subsequent) specific fixture(s), other light fixtures are not switched when the first specific fixture is switched and the fixture-mounted transmitter on the first specific fixture produces an output signal. Those skilled in the art will recognize that the switching system of the present invention enables other operational possibilities. Another use of this “repeater” function for turning specific light fixtures on in sequential fashion is for the purpose of reducing peak load. In other words, as described above, in certain installations, a portion of the billing to the operator of the installation for power consumption is based on the peak load of that installation. Because power consumption peaks when electrical appliances are switched from off to on, peak consumption can be reduced by switching appliances on in sequential fashion rather than simultaneously, thereby helping to control the cost of operating those appliances.

Those skilled in the art who have the benefit of this disclosure will also recognize that certain changes can be made to the component parts of the apparatus of the present invention without changing the manner in which those parts function and/or interact to achieve their intended result. By way of example, those skilled in the art who have the benefit of this disclosure will recognize that (although not shown in the figures) it is useful to provide microcontroller 38 with an output to an LCD or other digital readout for diagnostic and/or programming purposes. It will also be recognized that it may be useful to provide a manually-activated switch on switch controller 28 for switching a light fixture during installation of the fixture, switch controller 28, and/or testing purposes. All such changes, and others that will be clear to those skilled in the art from this description of the preferred embodiment(s) of the invention, are intended to fall within the scope of the following, non-limiting claims.

What is claimed is:

1. A system for switching an electrical appliance comprising:
a transmitter for selectively producing a directional output signal;
a receiver having a sensor for detecting the directional output signal from said transmitter, said receiver producing an output signal when the directional output signal from said transmitter is detected by the sensor; and
a switch controller comprising a microcontroller and a connector, said connector being adapted for operably connecting said microcontroller to an electrical appliance, the microcontroller receiving the output signal from said receiver and outputting a signal to the electrical appliance through said connector for switching the electrical appliance.

2. The switching system of claim 1 wherein said switch controller is mounted to the electrical appliance.

3. The switching system of claim 1 wherein said transmitter produces either a laser or a low divergence infrared output signal when activated.

4. The switching system of claim 1 wherein said receiver is provided with sensors for recognizing infrared and laser output signals from said transmitter.

5. The switching system of claim 1 wherein said microcontroller is programmed to output a signal to the connector after a time delay during which the sensor detects the encoded directional output signal.

6. The switching system of claim 1 additionally comprising means for limiting divergence of the signal output from said transmitter.

7. The switching system of claim 6 wherein divergence of the signal output from said transmitter is limited to about 1.5° from the central axis of the output signal.

8. The switching system of claim 1 additionally comprising an LED mounted to said receiver in close proximity to the sensor.

9. The switching system of claim 1 wherein the sensor of said receiver comprises an array of photodiodes.

10. The switching system of claim 1 additionally comprising means for limiting divergence of the output signal from said transmitter to a beam diameter of approximately 3-4 feet at the distance at which said transmitter is located from the electrical appliance.

11. The switching system of claim 1 wherein said microcontroller either (a) reads an input representing previous operating state from non-volatile memory upon restoration of power or (b) is provided with battery back-up for maintaining current operating state in the event of loss of power.

12. The switching system of claim 1 wherein said microcontroller is programmed to output a signal to the connector after a time delay during which the sensor detects the directional output signal.

13. The switching system of claim 1 additionally comprising a sensor for adjusting the sensitivity of said receiver in response to ambient lighting conditions.

14. A system for switching an electrical appliance comprising:
a sensor presenting a target of relatively small size;
a remote for transmitting a signal in the form of a low divergence beam for aiming at said sensor and encoding a signal for receipt by said sensor; and
a microcontroller for receiving an output from said sensor when said sensor detects a signal from said transmitter, said microcontroller being programmed to produce an output for switching an electrical appliance upon receipt of the output from said sensor.

15. The switching system of claim 14 wherein said microcontroller is programmed not to produce an output for switching an electrical appliance unless more than one output is received from said sensor within a pre-selected period of time.

16. The switching system of claim 15 wherein said microcontroller either (a) reads an input representing previous operating state from non-volatile memory upon restoration of power or (b) is provided with battery back-up for maintaining current operating state in the event of loss of power.

17. The switching system of claim 14 additionally comprising an ambient light sensor for producing an output to said microcontroller, said microcontroller being programmed to produce an output to the switching device for switching an electrical appliance depending upon the level of ambient light.

18. The switching system of claim 14 wherein said microcontroller is programmed to ignore signals from said sensor when said sensor detects an encoded signal from said transmitter either for a selected period of time or until receipt of a second encoded signal from said transmitter.

19. A method of switching an electrical appliance comprising the steps of:
producing a directional output signal by limiting the divergence of the signal output from a transmitter;
aiming the directional output signal from the transmitter at a sensor located on an electrical appliance;
outputting a signal from the sensor when the sensor detects the output signal from the transmitter;
outputting a signal from a microcontroller upon receipt of the output signal from the sensor by the microcontroller; and
activating a switching device upon receipt of the output signal from the microcontroller to switch the electrical appliance.

20. The method of claim 19 in which the microcontroller outputs a signal to the switching device only when the sensor detects multiple signals within a pre-selected period.

21. The method of claim 19 additionally comprising the step of encoding the directional signal output from the transmitter to cause the microcontroller to operate in one or more pre-programmed modes.

22. The method of claim 21 wherein one of the encoded signals causes the microcontroller to ignore signals from the sensor either for a pre-programmed period of time or until the sensor again detects the same encoded signal.

23. The method of claim 21 additionally comprising adjusting sensitivity in response to changes in ambient light.

24. The method of claim 19 additionally comprising the step of writing to non-volatile memory when the microcontroller produces an output signal.

25. The method of claim 19 wherein a second transmitter is mounted on the electrical appliance and the microcontroller, upon receipt of the output signal from the sensor, causes the second transmitter to produce a corresponding second directional output signal, the second directional output signal being aimed at a sensor located on a second electrical appliance.

26. The method of claim 25 wherein the microcontroller causes the second transmitter to produce the second directional output signal a pre-selected time after receipt of the output signal from the sensor.

27. The method of claim 19 additionally comprising the step of switching the electrical appliance off after a pre-selected period of time.
